(19) United States
(12) Patent Application Publication
(10) Pub. No.: US 2025/0069510 A1
(43) Pub. Date: Feb. 27, 2025

(54) Control of a Motor Vehicle

(71) Applicant: Bayerische Motoren Werke Aktiengesellschaft, Muenchen (DE)

(72) Inventors: Bernhard GASSER, Muenchen (DE); Philipp SCHWEIGER, Haidholzen (DE)

(21) Appl. No.: 18/813,151

(22) Filed: Aug. 23, 2024

(30) Foreign Application Priority Data
Aug. 24, 2023 (DE) 10 2023 122811.0

(51) Int. Cl. G08G 1/16; B60W 30/095

(52) U.S. Cl. CPC G08G 1/166; B60W 30/0953; B60W 30/0956; B60W 2554/4041; B60W 2554/80

(57) ABSTRACT

A method for controlling a motor vehicle includes steps of making a wireless connection between the motor vehicle and a mobile device of a person outside the motor vehicle; determining a relative position of the mobile device with respect to the motor vehicle; determining a probable trajectory of the motor vehicle; determining a probable trajectory of the mobile device; comparing the trajectories on the basis of the relative position; and determining a possible collision between the motor vehicle and the person.

### CROSS REFERENCE TO RELATED APPLICATION

This application claims priority under 35 U.S.C. § 119 from German Patent Application No. DE 10 2023 122 811.0, filed Aug. 24, 2023, the entire disclosure of which is herein expressly incorporated by reference.

### BACKGROUND AND SUMMARY

The present invention relates to the control of a motor vehicle. In particular, the invention relates to the avoidance of a collision between the motor vehicle and a person.

A motor vehicle comprises a number of sensors for scanning its environment. As such, a stationary or moving object that is about to collide with the motor vehicle can be identified. By way of example, a pedestrian or a cyclist moving in the region of the motor vehicle can be ascertained as a possible collision target. The motor vehicle can be controlled in such a way as to avoid a collision or to lessen consequences of a collision. This can be accomplished by triggering a pre-crash system.

Sensors of the motor vehicle can penetrate only specific obstacles and acquire only specific information. In some situations, for example when a person is moving across the vehicle and there is an opaque obstacle between the vehicle and the person, for instance vegetation or a wall, the person cannot be detected from the motor vehicle.

An object on which the present invention is based is to provide an improved technique for avoiding a collision between a motor vehicle and a person outside the motor vehicle. The invention achieves this object by means of the subjects of the independent claims. Dependent claims convey preferred embodiments.

A method for controlling a motor vehicle comprises steps of making a wireless connection between the motor vehicle and a mobile device of a person outside the motor vehicle; determining a relative position of the mobile device with respect to the motor vehicle; determining a probable trajectory of the motor vehicle; determining a probable trajectory of the mobile device; comparing the trajectories on the basis of the relative position; and determining a possible collision between the motor vehicle and the person.

Determining the relative position allows the probable trajectories to be compared with one another with improved precision. A possible collision between the motor vehicle and the person can be predicted with improved certainty. The person can be warned about the possible collision, and/or the motor vehicle can be controlled in such a way as to avoid the collision. This can be accomplished by activating a longitudinal control system of the motor vehicle in order to accelerate or decelerate the motor vehicle; or a lateral control system in order to change a direction of travel of the motor vehicle. Additionally, a pre-crash system can be triggered in order to alleviate the consequences of a collision with the person as far as possible.

The relative position of the mobile device with respect to the motor vehicle can be determined by way of the wireless connection. This can involve in particular evaluating a radiometric parameter during the transmission of a signal between the motor vehicle and the mobile device. The mobile device can operate as a transmitter and the motor vehicle can operate as a receiver, or vice versa. A receiver can determine a direction from which it receives a signal from the transmitter. A distance of the transmitter from the receiver can be determined on the basis of a signal strength or a transfer time of the signal. The wireless connection can comprise a Bluetooth connection, in particular based on the Bluetooth Low Energy (BLE) standard. A transmitter can be located by a receiver by means of methods that were introduced around 2019 with Bluetooth version 5.1. Radio signals used for the wireless connection can penetrate or go around an item that interrupts or impedes a direct line of sight between the motor vehicle and the person. The determined relative position may be independent of an absolute position that can be determined by the mobile device or by the motor vehicle, for example by means of a receiver for a satellite-assisted navigation system (GNSS).

The mobile device is preferably a personal device associated with the person. The mobile device can in particular comprise a smartphone, a smartwatch, a tablet computer, a laptop computer or a wearable computer. In another embodiment, the mobile device can also be worn on the body of the person (wearable). A wearable computer can be worn by the person on their body and may be in the form of a smartwatch, smartglasses or a headset, for example. By avoiding a collision between the motor vehicle and the mobile device, there is a high probability of it being possible to prevent a collision between the motor vehicle and the person.

In a more preferred embodiment, a further wireless connection is made between the motor vehicle and the mobile device. The relative position can be determined by way of the further wireless connection. In this case, data transfer can take place by way of the first wireless connection mentioned and position determination can take place by way of the second wireless connection mentioned. The further wireless connection can comprise a wideband connection, in particular an ultra-wideband (UWB) connection. UWB can be used to determine the relative position of the mobile device with respect to the motor vehicle quickly, accurately and reliably. Data relating to a trajectory of the motor vehicle or the mobile device can be transmitted by way of the first wireless connection.

The probable trajectory of the motor vehicle can be determined on the basis of one or more information sources aboard the motor vehicle. Preferably, the probable trajectory is determined on the basis of a direction of travel, a speed of travel, an acceleration, a course of a road being traveled on or a planned route. The probable trajectory can be determined by evaluating sensor values from one or more sensors aboard the motor vehicle. Such sensors can comprise an acceleration sensor, a position sensor, a steering angle sensor or a sensor for scanning an environment. An environment sensor can comprise for example a camera, a radar sensor, a LiDAR sensor or an ultrasonic sensor.

The probable trajectory of the mobile device is normally less precisely predictable when the person is not attached to a specific means of transport. By way of example, a pedestrian has great freedom in their choice of direction; a cyclist or a scooterist is a little more limited, but still freer than a passenger vehicle, for example. Assuming that the person could be a pedestrian, the probable trajectory can be determined on the basis of a direction of movement, a speed of movement, an acceleration, a course of a path being used by the person or a planned route. To this end, the mobile device can comprise various sensors, in particular a position sensor or an acceleration sensor. A specific geographical position can be compared with map material in order to determine the site of surrounding paths or items.

An acceleration of the mobile device can be taken as a basis for determining a type of motion of the person. The probable trajectory of the mobile device can be determined on the basis of the type of motion. The type of motion can indicate the means of transport by which the person is moving. A particularly uniform movement can indicate an electric scooter, a rhythmic movement can indicate a bicycle and an oscillating movement can indicate that the person is a pedestrian. In this case, a gait of the person can also be determined. As such, it is possible to distinguish between for instance strolling, going for a walk, jogging or running. The probable trajectory of the mobile device can be determined with further improvement as a result.

It should be noted that the trajectories may be increasingly inaccurate with increasing distance from a current situation. It is therefore preferred for a probability of an imminent collision to be determined with respect to inaccuracies of the determined probable trajectories. Should the probability exceed a predetermined threshold value, a possible collision between the motor vehicle and the person can be assumed. Preferably, an indication of the probability is provided aboard the motor vehicle. The indication can be output only if the probability exceeds a predetermined threshold value. It is particularly preferred for the imminent collision to be determined for a collision location. The indication of the probability can be provided on a graphical representation of the collision location.

In a particularly preferred embodiment, a graphical representation of locations in the environment of the motor vehicle is presented aboard the motor vehicle, wherein a graphical indication of a specific probability of the location being a collision location is presented at each of the locations. To put it another way, surroundings of the motor vehicle can be graphically represented and locations at which a collision with a person is probable can be highlighted. By way of example, a warning symbol can be displayed when a possible collision has been determined. The warning symbol can assume different colors according to the determined probability. By way of example, it is possible here to use the traffic light system in which a green color expresses no significant determined probability, an amber color expresses an average probability and a red color expresses a high probability. Instead of the symbol, a region of the environment can also be presented in color in the representation.

The technique described herein for determining a possible collision between the motor vehicle and a person can be extended to multiple persons with multiple mobile devices. The graphical representation can cumulatively take account of specific probabilities of collision. As such, a region in which there are numerous low probabilities for the collision with a respective person can have a high probability of collision with a person all in all and be presented in correspondingly conspicuous fashion.

Information relating to collision determination can be exchanged between the motor vehicle and the mobile device in both directions. According to the present invention, it is particularly preferred for trajectory data to be transmitted from the mobile device to the motor vehicle, and for the trajectories to be compared by the motor vehicle. The motor vehicle can have multiple ways of avoiding a collision. These can include a warning system, a control system or a pre-crash system. It is likewise possible for a possible collision to be determined by the mobile device, however.

In another embodiment, a possible collision is not determined if there is a protective obstacle between the motor vehicle and the mobile device. A protective obstacle can comprise an obstacle for which it can be assumed that the person cannot negotiate the obstacle. Such an obstacle can comprise a noise barrier, a watercourse or a building wall, for example. Protective obstacles may be recorded in map information that may be available for the comparison of the trajectories. In particular, the motor vehicle can use high-accuracy map data that can be downloaded dynamically from an external entity. Optionally, a sensor of the motor vehicle can be used to scan an environment of the motor vehicle and to determine a protective obstacle. Data about the protective obstacle can be forwarded to the external entity in order to update available map data there.

According to another aspect of the present invention, an apparatus for controlling a motor vehicle comprises a device for determining a probable trajectory of the motor vehicle; an interface for making a wireless connection between the motor vehicle and a mobile device of a person outside the motor vehicle; and a processing device. The processing device is configured here to receive an indication of a probable trajectory of the mobile device; to determine a relative position of the mobile device with respect to the motor vehicle; to compare the trajectories with one another on the basis of the relative position; and to determine a possible collision between the motor vehicle and the person.

The apparatus and in particular the processing device may be configured to carry out part or all of a method that is described herein.

To this end, the processing device may be configured to be electronic and for example comprise an integrated circuit, a programmable logic chip or a programmable microcomputer. The method may be implemented in the form of a configuration or as a computer program product containing program code means for the processing device. The configuration or the computer program product may be stored on a computer-readable data carrier. Features or advantages of the method can apply to the apparatus, or vice versa.

A motor vehicle can comprise an apparatus that is described herein. The motor vehicle preferably comprises a motorcycle, a passenger vehicle, a truck or a bus.

A mobile device comprises a device for determining a probable trajectory of the mobile device; an interface for making a wireless connection to a motor vehicle; and a processing device configured to transmit the probable trajectory of the mobile device to the motor vehicle.

More preferably, both the apparatus aboard the motor vehicle and the mobile device are each configured to perform relative position determination by way of a wireless connection. The apparatus and the mobile device can each have here a further interface for making a further wireless connection. The further wireless connection can be made in particular by way of UWB.

A system comprises a motor vehicle that is described herein and a mobile device that is described herein.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system;

FIG. 2 illustrates a flowchart for a method; and

FIG. 3 illustrates an exemplary representation of a map of the surroundings containing an indication of a possible collision location.

### DETAILED DESCRIPTION OF THE DRAWINGS

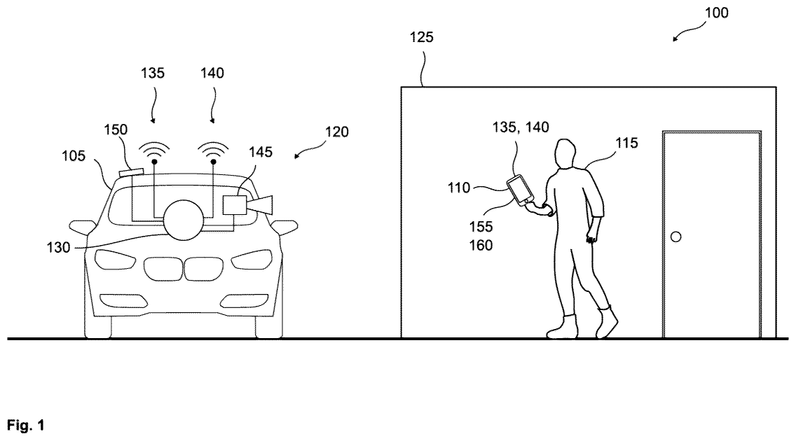

FIG. 1 shows a system 100 comprising a motor vehicle 105 and a mobile device 110. The mobile device 110 is associated with a person 115 who is carrying the mobile device 110. An apparatus 120 is fitted aboard the motor vehicle 105.

The motor vehicle 105 and the mobile device 110 are relatively close to one another, and so movements by the motor vehicle 105 and the person 115 mean that a collision is at least possible. The person 115 cannot be directly seen from the motor vehicle 105 because they are behind an obstacle 125. A technique is proposed in order to determine a possible collision between the person 115 and the motor vehicle 105 with high quality nevertheless and to permit prevention.

The apparatus 120 comprises a processing device 130, a first wireless interface 135, which preferably operates according to a Bluetooth standard, more preferably Bluetooth Low Energy, and a second wireless interface 140, which preferably operates by means of ultra-wideband UWB. Additionally, there may be provision for a sensor 145 for scanning the environment of the motor vehicle 105. The sensor 145 may be configured to scan an environment of the motor vehicle 105. More optionally, there is provision for a position sensor 150, which preferably operates as a receiver of a satellite-assisted navigation system GNSS.

The mobile device 110 preferably likewise comprises wireless interfaces 135 and 140 and can also comprise a sensor 145 and/or a position sensor 150. The sensor 145 can in particular comprise an acceleration sensor.

A wireless connection between the motor vehicle 105 and the mobile device 110 can be made by means of the first interface 135. The first interface 135 or preferably the second interface 140 can be used to determine a relative position between the motor vehicle 105 and the mobile device 110. The relative position can comprise a distance and/or a direction. If there is no provision for a second interface 140 on the motor vehicle 105 or on the mobile device 110, the first interface 135 can be used for this purpose.

Position determination by means of UWB normally uses multiple transmitting/receiving units (transceivers) fitted at different positions on the motor vehicle 105. Radio impulses can be transmitted by way of the different transceivers in a predetermined order and at predetermined intervals of time. The mobile device 110 can receive the impulses in succession. Distances between the individual transceivers and the mobile device 110 are slightly different, which means that transfer times for the impulses are likewise slightly different. Given knowledge of the locations at which the transceivers are fitted on the motor vehicle 105, differing times for successive received impulses can be used to determine a position of the mobile device 110 with respect to the motor vehicle 105.

Based on the relative position, a possible imminent collision can be determined on the basis of probable trajectories of the motor vehicle 105 and the mobile device 110, or the person 115. The motor vehicle 105 can determine the probable trajectory for example on the basis of a course of a road being traveled on, a speed of movement or a planned route. The person 115 can determine the imminent trajectory similarly on the basis of a speed, an acceleration or a planned route. To this end, the mobile device 110 can comprise a processing device 155 and a sensor 160. The sensor 160 can in particular comprise an acceleration sensor.

The determined relative position and the probable trajectories can be evaluated alternatively by the motor vehicle 105 or by the mobile device 110. This can be accomplished by transferring appropriate information by way of the wireless connection of the first interfaces 135. It should be noted that it is mentioned herein that the motor vehicle 105 communicates with the mobile device 110, this meaning that the apparatus 120 aboard the motor vehicle 105 uses one of the interfaces 135, 140 to communicate with a respectively corresponding interface 135, 140 of the mobile device 110.

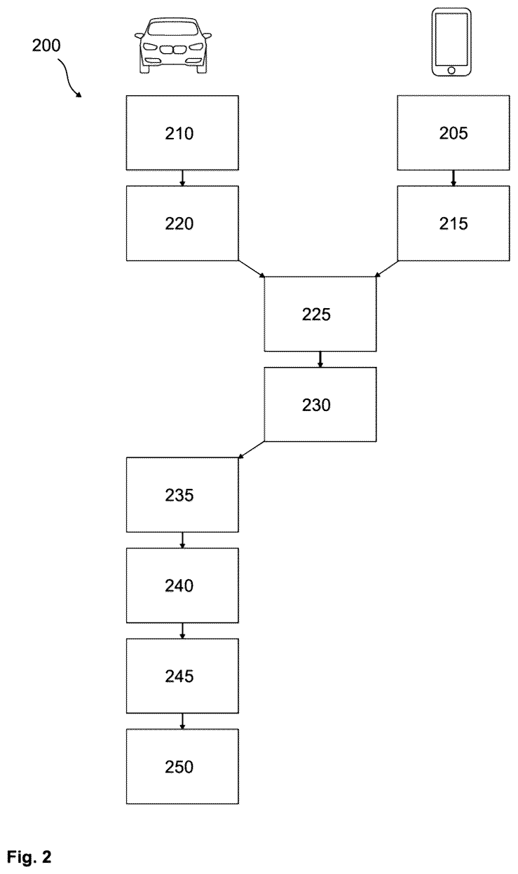

FIG. 2 shows a flowchart for an illustrative embodiment of a method 200. A left-hand area depicts method steps attributed to the motor vehicle 105, for example, and a right-hand area depicts steps attributed to a mobile device 110 of a person 115.

In a step 205, the mobile device 110 can determine a probable trajectory of the person 115, or the mobile device 110. At the same time, the motor vehicle 105 can determine a probable trajectory in a step 210. It is preferred for steps 205, 210 to be carried out continually.

In a step 215, the mobile device 110 can offer a wireless connection by way of the first interface 135. If the motor vehicle 105 comes into communication range, it can accept the connection in a step 220, with the result that a wireless connection is made between the motor vehicle 105 and the mobile device 110.

In a step 225, a relative position between the motor vehicle 105 and the mobile device 110 can be determined. This can be determined by way of the first wireless interfaces 135, but the relative position determination preferably takes place by way of the second interfaces 140. The relative position can comprise a direction and/or a distance of the respectively other communication partner 105, 110.

In a step 230, movement or trajectory data can be exchanged between the motor vehicle 105 and the mobile device 110. In the present case, it is assumed by way of example that the data are collected and processed further by the motor vehicle 105.

In a step 235, probable trajectories of the motor vehicle 105 and the mobile device 110 can be determined and compared with one another. In a step 240, a probability of a collision can be determined on the basis of the comparison. The collision can occur at a collision location at which the probable trajectories are within a predetermined relative distance of one another. The probability of a collision at a collision location can depend on a reliability with which it has been possible to determine one of the trajectories in this region.

In a step 245, it is possible to determine whether there is, between the motor vehicle 105 and the person 115, a protective obstacle preventing a collision at the specific collision location. If a protective obstacle cannot be identified, an indication of the possibly imminent collision can be provided. If the determined probability exceeds a predetermined threshold value, a warning can be output.

More optionally, the motor vehicle 105 can be controlled in a step 250 in such a way as to prevent the collision. This can be accomplished by controlling a movement of the motor vehicle 105 in such a way that the probable trajectory does not form a collision location with the probable trajectory of the mobile device 110, or the person 115. In particular, the motor vehicle 105 can be steered, accelerated or slowed.

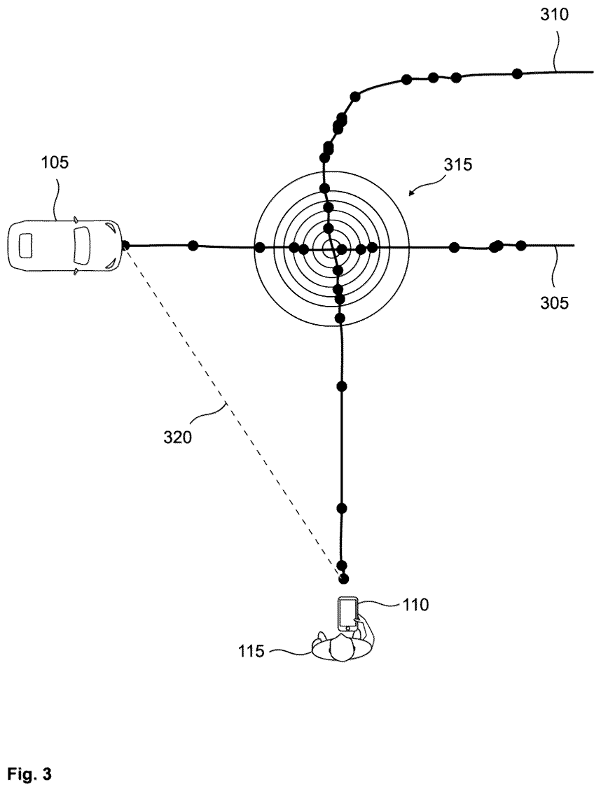

FIG. 3 shows an exemplary representation of a map of the surroundings of a motor vehicle 105. The representation can be provided on a display apparatus aboard the motor vehicle 105. The motor vehicle 105 has an associated first probable trajectory 305. A mobile device 110 of a person 115 has an associated second probable trajectory 310. Dark-colored circles on the trajectories 305, 310 denote times at which the motor vehicle 105, or the mobile device 110, is at the position shown.

By way of example, the trajectories 305, 310 form a possible collision location 315. A distance between the mobile device 110 and the motor vehicle 105 at the collision location 315 is not readily identifiable in this representation, as there is no representation of the time at which the participants 105, 110 are each at which location. As such, times at which the participants 105, 110 reach the possible collision location 315 could differ from one another in terms of timing. A probability of a collision at the collision location 315 is sufficiently high in the present example to output a warning, however. By way of example, the warning can be highlighted by a color-coded region, by a symbol or, as shown, by concentric circles. Additionally or alternatively, an audible or haptic warning, for example, can be provided.

To be able to compare the probable trajectories 305, 310 with one another and determine a possible collision location 315, it is crucial to determine a relative position 320 of the mobile device 110 with respect to the motor vehicle 105 at an initial time. The relative position 320 is shown by a broken line and symbolizes a direction and a distance determined between the motor vehicle 105 and the mobile device 110.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
105 motor vehicle
110 mobile device
115 person
120 apparatus
125 obstacle
130 processing device
135 first wireless interface, preferably BLE
140 second wireless interface, preferably UWB
145 sensor
150 position sensor
155 processing device
160 sensor
200 method
205 determine first probable trajectory
210 determine second probable trajectory
215 offer connection
220 accept connection
225 determine relative position
230 transmit movement data
235 compare trajectories
240 determine probability of a collision
245 output warning
250 control motor vehicle
305 first probable trajectory (of the motor vehicle)
310 second probable trajectory (of the mobile device)
315 collision location
320 relative position

What is claimed is:

1. A method for controlling a motor vehicle, the method comprising the steps of:
making a wireless connection between the motor vehicle and a mobile device of a person outside the motor vehicle;
determining a relative position of the mobile device with respect to the motor vehicle;
determining a probable trajectory of the motor vehicle;
determining a probable trajectory of the mobile device;
comparing the probable trajectories on the basis of the relative position; and
determining a possible collision between the motor vehicle and the person based on the comparing.

2. The method according to claim 1, wherein the relative position is determined by way of the wireless connection.

3. The method according to claim 2, wherein
a further wireless connection is made between the motor vehicle and the mobile device; and
the relative position is determined by way of the further wireless connection.

4. The method according to claim 1, wherein
the probable trajectory of the motor vehicle is determined on the basis of a direction of travel, a speed of travel, an acceleration, a course of a road being traveled on or a planned route.

5. The method according to claim 1, wherein
the probable trajectory of the mobile device is determined on the basis of a direction of movement, a speed of movement, an acceleration, a course of a path being used by the person or a planned route.

6. The method according to claim 5, wherein
an acceleration of the mobile device is taken as a basis for determining a type of motion of the person; and
the probable trajectory is determined on the basis of the type of motion.

7. The method according to claim 1, wherein
a probability of an imminent collision is determined; and
an indication of the probability is provided aboard the motor vehicle.

8. The method according to claim 7, wherein
a graphical representation of locations in an environment of the motor vehicle is presented aboard the motor vehicle;
wherein a graphical indication of a specific probability of a location being a collision location is presented at each of the locations.

9. The method according to claim 1, wherein the probable trajectories are compared with one another by the motor vehicle.

10. The method according to claim 1, wherein
a possible collision is not determined when there is a protective obstacle between the motor vehicle and the mobile device.

11. An apparatus for controlling a motor vehicle, the apparatus comprising:
a device for determining a probable trajectory of the motor vehicle;
an interface for making a wireless connection between the motor vehicle and a mobile device of a person outside the motor vehicle; and
a processing device configured to:
receive an indication of a probable trajectory of the mobile device;
determine a relative position of the mobile device with respect to the motor vehicle;
compare the probable trajectories with one another on the basis of the relative position; and
determine a possible collision between the motor vehicle and the person.

12. A motor vehicle comprising an apparatus according to claim 11.

13. A mobile device, comprising:
a device for determining a probable trajectory of the mobile device;
an interface for making a wireless connection to a motor vehicle; and
a processing device configured to transmit the probable trajectory of the mobile device to the motor vehicle.

14. A system, comprising:
a motor vehicle comprising:
a device for determining a probable trajectory of the motor vehicle;
an interface for making a wireless connection between the motor vehicle and a mobile device of a person outside the motor vehicle; and
a processing device configured to:
receive an indication of a probable trajectory of the mobile device;
determine a relative position of the mobile device with respect to the motor vehicle;
compare the probable trajectories with one another on the basis of the relative position; and
determine a possible collision between the motor vehicle and the person; and
a mobile device comprising:
a device for determining a probable trajectory of the mobile device;
an interface for making a wireless connection to a motor vehicle; and
a processing device configured to:
transmit the probable trajectory of the mobile device to the motor vehicle.
